(19) United States
(12) Patent Application Publication
(10) Pub. No.: US 2020/0076359 A1
(43) Pub. Date: Mar. 5, 2020

(54) ENVIRONMENT-ADJUSTING, SUPPORT SYSTEM FOR SOLAR ENERGY DEVICES AND ENVIRONMENT-ADJUSTING, SOLAR ENERGY APPARATUS

(71) Applicant: Patrick R.E. Bahn, Washington, DC (US)

(72) Inventor: Patrick R.E. Bahn, Washington, DC (US)

(21) Appl. No.: 16/138,964

(22) Filed: Sep. 21, 2018

Related U.S. Application Data
(60) Provisional application No. 62/561,391, filed on Sep. 21, 2017.

(51) Int. Cl. H02S 30/10; H02S 20/32

(52) U.S. Cl. CPC H02S 30/10; H02S 20/32

(57) ABSTRACT

In a first embodiment, the present invention is directed to an environment-adjusting, support system for solar energy devices wherein the support system comprises at least one vertical support element secured to a support surface, and at least one rotary element securing a solar energy device to said vertical support elements. The support system may further comprise at least one adjustable counterweight, a linear damper, and/or an energy damper. In a second embodiment, the present invention is an environment-adjusting, support system for solar energy devices. The support system preferably comprises a pair of vertical support elements, a pair of securing members, a first connecting element connecting the pair of vertical support elements, a second connecting element connecting the pair of securing members, and at least one rotary element. In a third embodiment, the present invention is an environment-adjusting, solar energy apparatus which also comprises a solar energy device.

### CROSS-REFERENCE TO RELATED APPLICATIONS

The present application is a nonprovisional application of and claims the priority benefit of U.S. Provisional Patent Application Ser. No. 62/561,391, filed Sep. 21, 2017, which is incorporated herein by reference in its entirety.

### BACKGROUND OF THE INVENTION

### Field of the Invention

The present invention generally relates to devices, components, and systems in the solar energy industry. More specifically, the present invention relates to an environment-adjusting, support system for solar energy devices, and also to an environment-adjusting, solar energy apparatus.

### Description of the Related Art

Contemporary designs of various solar apparatuses are based on the earliest accepted designs that are decades old. While the state of the art has advanced tremendously in recent decades, the method and design of the solar apparatuses remains bulky, robust, cumbersome, and less adaptable to the many of structures and buildings to provide the most efficient manner of energy generation. At the same time, the design and function of classic roofs remains focused on physically protecting the structure from the outer environment, providing thermal protection, and preventing rain or snow from damaging the interior of the structure. These factors drive the design of roofs to prevent damage from snow accumulation by utilizing a sloped roof. These considerations rarely take into account incorporating energy efficient designs of rooftops to support he most efficient manner of energy generation of a solar apparatus.

Conventional solar apparatuses on flat roofs are similarly limited. Structural supports for solar apparatuses on flat roofs are typically reinforced with weighted robust installations to resist wind interference, wind forces, and wind loads. Solar arrays installed on a flat surface or flat roof need to be heavily reinforced from wind loads or snow/ice loads. This requires carefully engineered installation systems and may require roof reinforcement. More dynamic designs and adaptations are necessary to provide more efficient, effective and adjustable structural supports for solar apparatuses on flat roofs. Solar tracking systems are well known in the art as devices that are designed to follow the sun to better optimize the collection of solar energy from a solar apparatus. While solar tracking systems and adjustable structural supports for solar apparatus are well known, they are limited to hold/set specific optimum angles with no further adjustments or adaptation possible (see FIGS. 1 and 2). Adjustable solar trackers are also found in earlier supports for solar apparatuses. The adjustable solar trackers are designed to track the sun, but are limited in their ability to adapt to wind interference, wind forces, and wind loads (see FIG. 3).

Essentially in small PV installations, the mindset was driven to follow the rooflines of existing sloped roofs and the mindset in flat roofs was to set PV panels at angles that would optimize panel output. There has been no thinking about panel supports that could sway in the breeze and optimize support system costs rather then panel costs. When Panel costs were 80% of the system costs, these were natural thoughts, but now with low cost panels, it is appropriate to focus on matters that reduce the cost of the support systems.

Have you seen gentle wind in the willows? Have you heard how it softly blows? Have you watched the branches swaying where the weeping willow grows? Oh the wind in the willow is soothing when it blows so gently and soft. It is like the caress of Spring raindrops and warm sunshine from aloft.

Have you ever thought about living and how lucky we are to be here? I have to believe mother nature has blessed the earth with good cheer. Oh wind that blows through the willows, please carry this message along Tell Dear Old Mother Nature, our love for Her always is strong.—William Wismer

A Giant Oak stood near a brook in which grew some slender Reeds. When the wind blew, the great Oak stood proudly upright with its hundred arms uplifted to the sky. But the Reeds bowed low in the wind and sang a sad and mournful song.
“You have reason to complain,” the the Oak. “The slightest breeze that ruffles the surface of the water makes you bow your heads, while I, the mighty Oak, stand upright and firm before the howling tempest.”
“Do not worry about us,” replied the Reeds. “The winds do not harm us. We bow before them and so we do not break. You, in all your pride and strength, have so far resisted their blows. But the end is coming.”
As the Reeds spoke a great hurricane rushed out of the north. The Oak stood proudly and fought against the storm, while the yielding Reeds bowed low. The wind redoubled in fury, and all at once the great tree fell, torn up by the roots, and lay among the pitying Reeds.—Aesop
   Better to yield when it is folly to resist, than to resist stubbornly and be destroyed

It is possible to take the moral lessons of Aesop and Wismers poem of the wind in the willows and see the inspiration behind this invention.

Presently, there is not a cost efficient and effective way of providing breeze adjusting structural support for a solar apparatus on flat roofs that are adaptable to wind interference, wind forces, and wind loads or snow loads. Therefore, the method of design of the present invention will reduce costs of installation, by reducing loads transmitted to the support structure and by allowing lightweight support structures to support the panels rather than heavyweight support pieces. The Applicant is unaware of inventions or patents, taken either singly or in combination, which are seen to describe the present invention as claimed.

### SUMMARY OF THE INVENTION

In a first embodiment (or “rolling” embodiment), the present invention is directed to an environment-adjusting, support system for solar energy devices wherein the support system comprises at least one (preferably a pair of) vertical support element secured to a support surface, and at least one rotary element securing a solar energy device to said vertical support elements. The at least one rotary element allows the solar energy device to rotate in an axis connecting the vertical support elements such that the solar energy device is able to rotate under effects of environmental forces to minimize mechanical load transferred to the vertical support elements and the support surface. The support system may further comprise at least one adjustable counterweight, a linear damper, and/or an energy damper.

In a second embodiment (or “spinning” embodiment), the present invention is an environment-adjusting, support system for solar energy devices. The support system preferably comprises a pair of vertical support elements, a pair of securing members, a first connecting element connecting the pair of vertical support elements, a second connecting element connecting the pair of securing members, and at least one rotary element.

In a third embodiment, the present invention is an environment-adjusting, solar energy apparatus. The solar energy apparatus preferably comprises a solar energy device, at least one (preferably a pair of) vertical support element, and at least one rotary element.

Preferably, the third embodiment is substantially similar to the first embodiment but includes the solar energy device to form the solar energy apparatus. The solar energy apparatus may further comprise the at least one adjustable counterweight, an energy damper, and/or a linear damper.

### BRIEF DESCRIPTION OF THE DRAWINGS

FIG. 1 is a side view of prior art of a type of adjustable structural support for a solar apparatus;

FIG. 2 is a side view of prior art of a type of adjustable structural support for a solar apparatus;

FIG. 3 is a conceptual side view on an environmental drawing showing optimum repose angle of a solar panel at the winter solstice;

FIG. 4 is a conceptual side view on an environmental drawing showing optimum repose angle of a solar panel at the equinox;

FIG. 5 is a conceptual side view on an environmental drawing showing optimum repose angle of a solar panel at the summer solstice;

FIG. 6 is an environmental, perspective view of an embodiment of an environment-adjusting, support system for solar energy devices of the present invention;

FIG. 7 is an environmental, perspective view of the environment-adjusting, support system of FIG. 6, wherein the support system further comprises an adjustable counterweight, and wherein the adjustable counterweight is adjustable in angle and length, giving two degrees of freedom to adjust the center of gravity of the solar energy device system;

FIG. 8 is a detail view of a counterweight and a hinge assembly of the present invention;

FIG. 9 is a side view of the details of FIG. 8;

FIG. 10 is a side view of the details of FIG. 8;

FIG. 11 is a detail of FIG. 10 showing a detail of the vertical support element of the present invention;

FIG. 12 is a view of one method of passing electrical wires from the solar panel down to the support elements and onward to electrical equipment of the present invention;

FIG. 13 is a side view of an alternate embodiment of a rotary hinge with pass through elements of the present invention;

FIG. 14 is a top view of FIG. 13;

FIG. 15 is a side view of an alternate design of the counterweight system of the present invention;

FIG. 16 is a side view of an alternate design of the counterweight system of the present invention;

FIG. 17 is an environmental, side view of FIG. 7, showing how adjusting the adjustable counterweight results in a different angle of repose;

FIG. 18 is an environmental, side view of FIG. 7, showing how adjusting the adjustable counterweight results in a different angle of repose;

FIG. 19 is an environmental, side view of FIG. 7, showing how adjusting the adjustable counterweight results in a different angle of repose;

FIG. 20 an environmental, side view of FIG. 6, with wind;

FIG. 21 is an environmental, side view of FIG. 7, with snow;

FIG. 22 is an environmental, side view of FIG. 7, responding to snow;

FIG. 23 is an environmental, side view of FIG. 7, responding to snow;

FIG. 24 is an environmental, perspective view of the environment-adjusting, support system of FIG. 6, wherein the support system further comprises an adjustable counterweight and a linear damper;

FIG. 25 is an environmental, side view of FIG. 24, showing how adjusting the adjustable counterweight results in a different angle of repose for winter solstice;

FIG. 26 is an environmental, side view of FIG. 24, showing how adjusting the adjustable counterweight results in a different angle of repose for equinox;

FIG. 27 is an environmental, side view of FIG. 24, showing how adjusting the adjustable counterweight results in a different angle of repose for summer solstice;

FIG. 28 is an environmental, side view of FIG. 24, in snow;

FIG. 29 is an environmental, side view of FIG. 24, responding to snow;

FIG. 30 is an environmental, side view of FIG. 24, responding to wind;

FIG. 31 is an environmental, side view of FIG. 24, responding to wind;

FIG. 32 is an environmental, perspective view another embodiment of an environment-adjusting, support system for solar energy devices of the present invention, with a one-dimensional, adjustable counterweight;

FIG. 33 is an environmental, perspective view of FIG. 32, with the counterweight adjusted to winter solstice;

FIG. 34 is an environmental, perspective view of FIG. 32, with the counterweight adjusted for summer solstice;

FIG. 35 is an environmental, perspective view of a further embodiment of an environment-adjusting, support system for solar energy devices of the present invention, with a one-dimensional, adjustable counterweight and a linear damper;

FIG. 36 is an environmental, perspective view of FIG. 35, with the counterweight adjusted for summer solstice;

FIG. 37 is an environmental, perspective view of a further embodiment of an environment-adjusting, support system for solar energy devices of the present invention, with a spring-type linear damper;

FIG. 38 is an environmental, perspective view of FIG. 37, with the damper adjusted for equinox;

FIG. 39 is an environmental, perspective view of FIG. 37, with the damper adjusted for summer solstice;

FIG. 40 is a perspective view of another embodiment of an environment-adjusting, support system for solar energy devices of the present invention, with a two-dimensional, adjustable counterweight and a hinge pin at one edge;

FIG. 41 is a perspective, detailed view of FIG. 40;

FIG. 42 is a perspective view of a further embodiment of an environment-adjusting, support system for solar energy devices of the present invention, with an adjustable counterweight and an alternate orientation of the solar panel and hinge joint;

FIG. 43 is a perspective, detailed view of FIG. 42;

FIG. 44 is a perspective view of another embodiment of an environment-adjusting, support system for solar energy devices of the present invention;

FIG. 45 is an alternate view of FIG. 44;

FIG. 46 is a detail, side view of FIG. 44;

FIG. 47 a detail, side view of an alternate counterweight;

FIG. 48 a detail, side view of another alternate counterweight;

FIG. 49 is a side view of FIG. 47 in detail, with a guide bracket;

FIG. 50 is a side view of FIG. 44 in detail;

FIG. 51 is an environmental, perspective view of an embodiment of the present invention, with an energy damper;

FIG. 52 is a schematic view of a simple fluid damper of the present invention;

FIG. 53 is a plan view of a fluid damper of the present invention;

FIG. 54 is a side view of a schematic of a fluid damper with radial baffles;

FIG. 55 is a plan view of FIG. 54;

FIG. 56 is a side view schematic of an alternate embodiment of a fluid damper with a continuous, perforated baffle of the present invention;

FIG. 57 is a plan view of FIG. 56;

FIG. 58 is an environmental, perspective view of an embodiment of the present invention, with an adjustable counterweight and fixed energy damper;

FIG. 59 is a side view schematic of a simple fluid damper responding to motion;

FIG. 60 is a side view schematic of a simple fluid damper responding to motion;

FIG. 61 is an environmental, perspective view of another embodiment of the present invention, with a fluid damper used as an adjustable counterweight set for winter solstice;

FIG. 62 an environmental, perspective view of FIG. 61, set for equinox;

FIG. 63 an environmental, perspective view of FIG. 61, set for summer solstice;

No drawings for FIGS. 64-69; and

FIG. 70 is a rear view of FIG. 42, showing adjustable counterwights.

It should be understood that the above-attached figures are not intended to limit the scope of the present invention in any way.

### DETAILED DESCRIPTION OF THE PREFERRED EMBODIMENTS

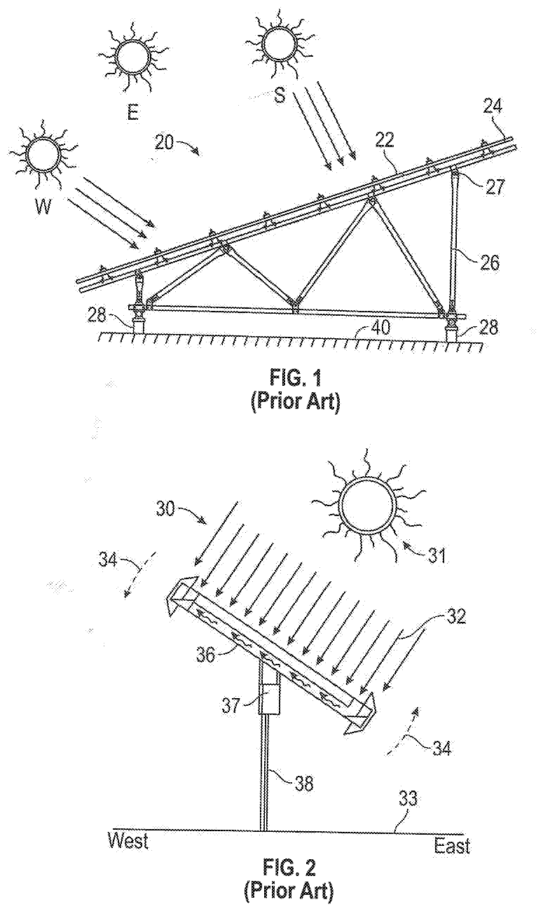

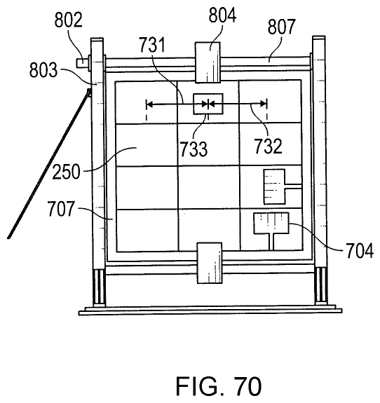

Referring to FIGS. 1-70, the present invention is an environment-adjusting, support system 100 for solar energy devices, and also an environment-adjusting, solar energy apparatus that includes a solar energy device 250.

Environment adjusting refers to the behavior of a solar energy device which reacts to wind, snow, animal or other mechanical loads by moving to a minimum torque angle so as to reduce mechanical forces transmitted to the supporting structures for the purposes of reducing cost of installation, improving speed of installation and reducing regulatory impacts by making solar energy devices ‘temporary’ in installation.

In a first embodiment (or “rolling” embodiment), as shown in FIGS. 6, the present invention is an environment-adjusting, support system 100 for solar energy devices. The support system comprises at least one vertical support element 720 and at least one rotary element 706. The support system may further comprise at least one adjustable counterweight 704, a linear damper 726, and/or an energy damper 606.

Preferably, the at least one vertical support element 720 is a pair of vertical support elements are secured to a support surface, such as the ground or roof of a building, a house, etc. Each of the vertical support elements comprises a first end, a second end, and a body extending between the first end and the second end. The vertical support elements 720 are designed to support the body and attachable solar energy device(s) 250 (such as, but not limited to, a solar panel or a photovoltaic panel) but to be fabricated in such a way that the connecting body may freely rotate or allow an attached solar energy device to rotate as seen in FIG. 6. A photovoltaic panel is any lightweight surface made of a material to convert solar photons to electricity such as silicon, organic paints, Pereskovites or other photo-electric material. A solar panel is as is commonly understood is a device for converting sunlight into electrical energy. These are known to PHOSITAs and are commonly available.

As a non-limiting example, the vertical support elements may be simple short rods attached to a support surface and designed to provide mechanical clearance between the solar energy device and the support surface when moved. The vertical support elements may be angled with respect to the support surface, may be straight vertical, or may be offset arms or curved as long as they provide vertical clearance between the solar energy device and the support surface.

The at least one rotary element 706 is for securing a solar energy device 250 to the vertical support elements 720. Non-limiting examples of the at least one rotary element are a hinge, a rod, a joint, a flexible material, and any combination thereof. The at least one rotary element allows the solar energy device 250 to rotate in an axis connecting the vertical support elements 720 such that the solar energy device 250 is able to rotate under effects of environmental forces (such as, but not limited to, wind, snow, etc.) to minimize mechanical load transferred to the vertical support elements 720 and the support surface 40.

The rotary element 706 may also be a flexible material providing support through tension but able to easily twist and rotate to provide a hinging or rotating motion between attachment points. This could be a thin leather strap, a weather resistant rope or a plastic ribbon.

As shown in FIG. 7, the environment-adjusting, support system 100 may further comprise at least one adjustable counterweight 704, wherein the at least one adjustable counterweight is secured to the solar energy device 250 such that at least one adjustable counterweight 704 causes the solar energy device 250 to maintain a preferred angle of repose e200 (Theta 200) of the solar energy device 250 relative to the support surface 40 due to gravitational forces. The adjustable counterweight 704 may be adjustable in one or two dimensions to adjust the center of gravity of the solar energy device 250 to create a gravitational torque and create a preferred, adjustable angle of repose of the solar energy device 250 compared to the vertical support element 720.

The solar energy device 250 will rotate under effects of environmental forces and minimize mechanical forces transferred to the vertical support elements 720 and the support surface 40.

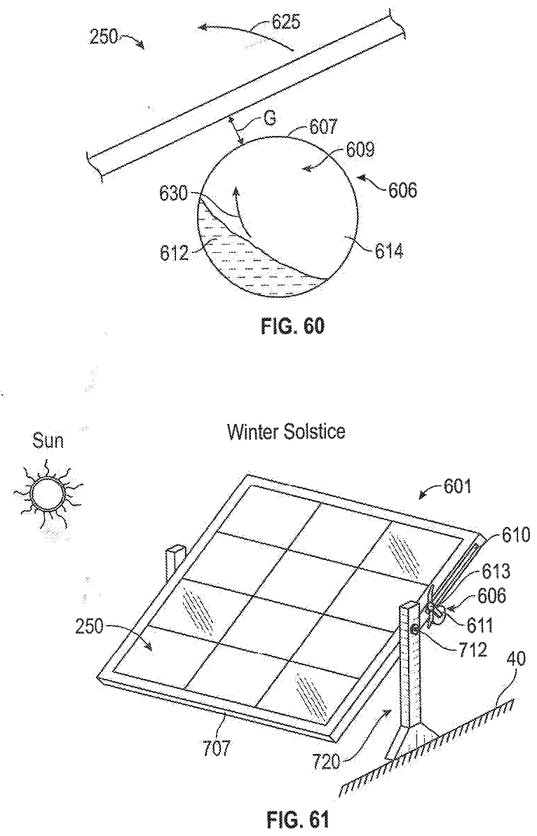

As a non-limiting example shown in FIG. 61, the at least one adjustable counterweight 704 is an energy damper 606. As shown in FIG. 60, an energy damper 606 is any device attached to the solar energy device 250 which converts kinetic energy of the energy damper 606 into mechanical heat within the energy damper 606 by the internal motion of fluids or particles contained.

The at least one adjustable counterweight 704 is adjustable to a surface of the solar energy device 250 in a distance from a hinge point 706 of the solar energy device 250 and offset away from the surface of the solar energy device 250 to adjust the center of gravity of the solar energy device 250.

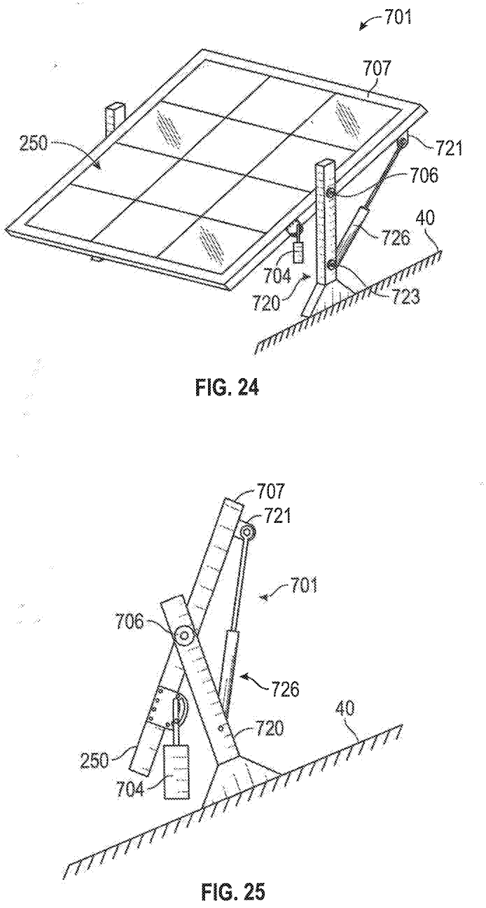

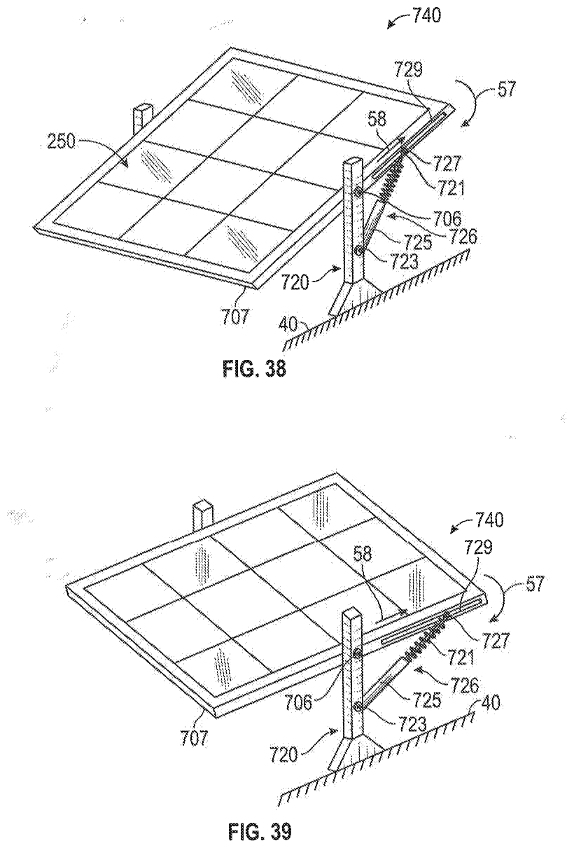

As shown in FIG. 24, the environment-adjusting, support system 100 may further comprise a linear damper 726 connecting the solar energy device 250 and one of the vertical support elements 720. Preferably, the linear damper 726 adjustably connects the solar energy device 250 and one of the vertical support elements 720. The linear damper 726 may be connected to a preferred location on the solar energy device 250 to maintain a long term angle of repose or may be seasonally adjusted to provide seasonal angles of repose to the solar energy device 250. As shown in FIG. 38, an adjustable connection 729 for the linear damper 726 is a set of attachment points in a linear row such as a series of holes or a slot where the attachment point of an adjustable linear damper 726 may be set and retained but then easily later set to another position and maintained.

The linear damper 726 is preferably any device consisting of two ends where the device may lengthen or shorten and, via friction, absorb energy in movement. As non-limiting examples, a shock absorber is a subset of linear dampers 726 but a gas-type linear damper is preferred. The linear damper 726 may include low pressure gas spring devices or low force spring dampers. The linear damper 726 may be a simple rod friction fit inside a tube to provide drag and slow the rate of motion of the solar energy device 250.

As shown in FIG. 52, the environment-adjusting, support system may further comprise an energy damper 606 that is secured to the solar energy device 250. An energy damper 606 is preferably any device attached to the solar energy device 250 which converts kinetic energy of the energy damper 606 into mechanical heat within the energy damper 606 by the internal motion of fluids or particles contained.

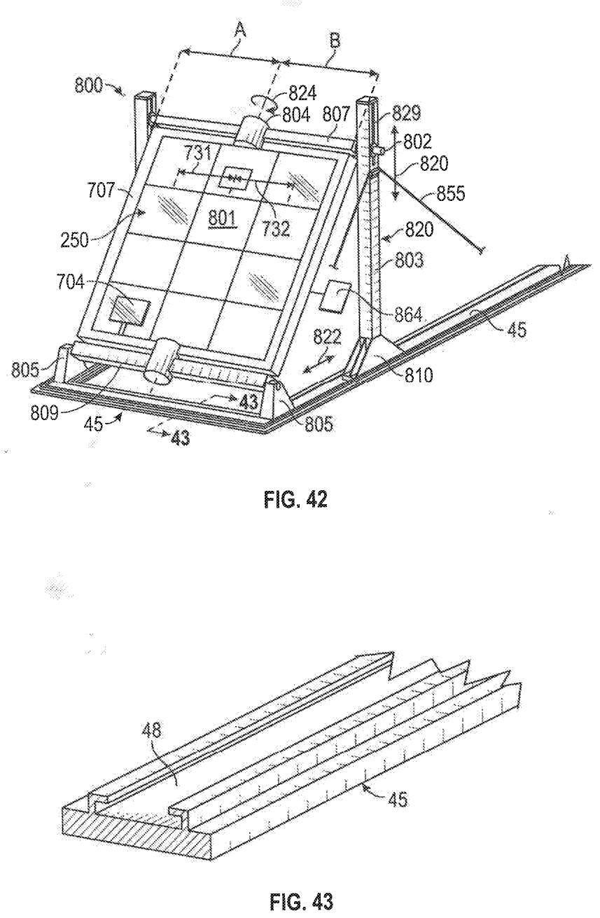

In a second embodiment (or “spinning” embodiment), as shown in FIG. 42, the present invention is an environment-adjusting, support system 800 for solar energy devices 250. The support system 800 preferably comprises a pair of vertical support elements 820, a pair of securing members 805, a first connecting element 807 connecting the pair of vertical support elements 820, a second connecting element 809 connecting the pair of securing members 805, and at least one rotary element 804. The support system may further comprise at least one adjustable counterweight 704,731,732.

The pair of vertical support elements 820 is secured to a support surface, such as, but not limited to, a track 45. Each of the vertical support elements 820 comprises a first end, a second end, and a body extending between the first end and the second end. These three elements 820,807 provide a rigid linear support axis parallel to the next three described support elements 805,809.

The vertical support elements 820 are designed to support the attachable solar energy devices 250 but to be fabricated in such a way that the connecting body 707 may freely rotate or allow an attached solar energy device 250 to rotate as seen in FIG. 42.

The vertical support elements 820 may be simple short rods attached to a support surface 45 and designed to provide mechanical clearance between the solar energy device 250 and the support surface 45 when moved. The vertical support elements 820 may be angled with respect to the support surface 45, may be straight vertical, or may be offset arms or curved as long as they provide clearance between the solar energy device 250 and the support surface 45.

Each of the pair of securing members 805 is secured to the support surface 45 and is positioned forward of a corresponding vertical support element 820 of the vertical support elements 820.

The first connecting element 807 connects the pair of vertical support elements 820 wherein the first connecting element 807 comprises a first end, a second end, and a body extending between the first end and the second end of the first connecting element 807.

The second connecting element 809 connects the pair of securing members 805 wherein the second connecting element 809 comprises a first end, a second end, and a body extending between the first end and the second end of the second connecting element 809.

The at least one rotary element 804 is for securing a solar energy device 250 to the vertical support elements 720. Non-limiting examples of the at least one rotary element are a hinge, a rod, a joint, a flexible material, and any combination thereof. The at least one rotary element allows the solar energy device 250 to rotate in an axis connecting the vertical support elements 720 such that the solar energy device 250 is able to rotate under effects of environmental forces (such as, but not limited to, wind, snow, etc.) to minimize mechanical load transferred to the vertical support elements 720 and the support surface 40.

The at least one rotary element 804 is for securing a solar energy device 250 to the first connecting element 805 and the second connecting element 809. The at least one rotary element 804 allows the solar energy device 250 to rotate in an axis generally perpendicular of the first connecting element 807 and the second connecting element 809 such that the solar energy device 250 is able to rotate under effects of environmental forces to minimize mechanical load transferred to the vertical support elements 820 and the support surface 45.

As a non-limiting example shown in FIGS. 42 and 70, the at least one adjustable counterweight 704,731,732. The at least one adjustable counterweight 704,731,732 is adjustable to a surface of the solar energy device 250 in a distance from a hinge point 804 of the solar energy device 250 and offset away from the surface of the solar energy device 250 to adjust the center of gravity of the solar energy device 250.

In a third embodiment, the present invention is an environment-adjusting, solar energy apparatus 10. The solar energy apparatus 10 preferably comprises a solar energy device 250, a pair of vertical support elements 720, and at least one rotary element 706.

Preferably, the third embodiment is substantially similar to the first embodiment but includes the solar energy device 250 to form the solar energy apparatus 10. The solar energy apparatus 10 may further comprise the at least one adjustable counterweight 704, an energy damper 606, and/or a linear damper 726. To avoid redundancy, the description of the components 250, 606, 706, 720 and 726 may be obtained from above.

FIG. 1 shows common prior art for flat roof solar panel installations. Item 20 is the entire system of panels and supports. Item 22 is the solar panel. Item 26 is a vertical support element setting a fixed angle of repose for the year. Item 27 is a non-moving pin joint. Item 28 is an anchor attachment to a roof or ground. Item 24 is redundant. Also seen is the sun moving in inclination from winter to summer.

FIG. 2 is a solar tracking panel of prior art. Item 30 is the system as a whole. Item 31 is the sun moving from east to west. Item 32 are sun-rays striking at an optimal angle perpendicular to the solar panel 36, which rotates 34 matching the east west movement of the sun. Item 37 is the drive unit to move the panel 36, and 38 is a vertical pole firmly affixed to the ground.

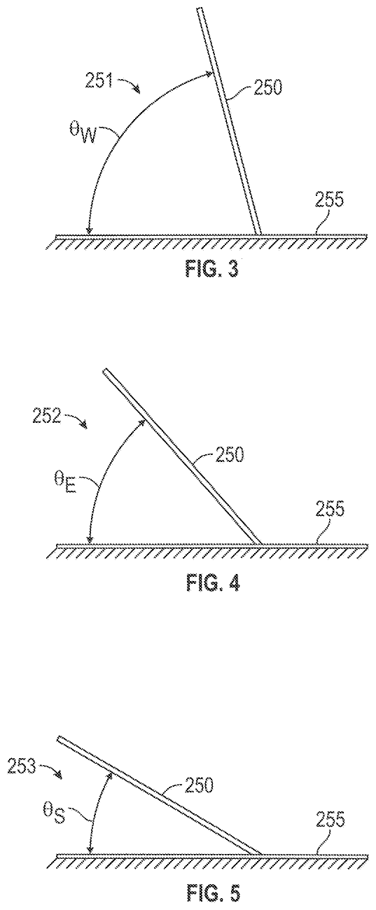

FIG. 3 is the optimal angle of repose for a solar panel at winter solstice. 250 is a notional panel. 251 is the angle of repose for a solar panel at winter solstice, this angle would nominally be or described by the equation ‘90 degrees less minus degrees latitude plus 23.5’. 255 is the earth's surface.

In FIG. 4, 252 is the optimal angle for the equinox, which is 90 degrees minus degrees latitude. 250 is the panel, and 255 is the earth's surface.

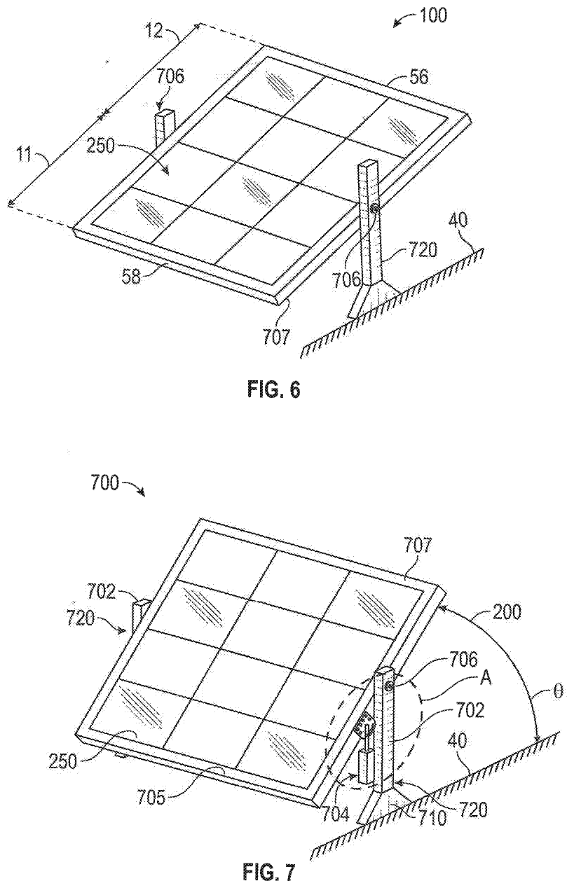

FIG. 5 depicts the optimal angle for the summer solstice, which is described with the equation ‘90 degrees less degrees latitude less 23.5’.250 is the panel, and 255 is the earth's surface.

FIG. 6 is a schematic view of the preferred embodiment or “rolling” embodiment minus the counterweights. 100 is the system. 56 is the top rail of the solar panel support frame. 58 is the bottom rail of the support frame. 250 is the solar photovoltaic (PV) panel. 11 and 12 are the relative measurements of the point of rotation in the PV support frame 707. 11 and 12 may be of equal length or may be of mildly different lengths. The ratio of the lengths will become ungainly at a certain point, currently estimated to be around 1.2:1. An increase of offset in length between 11 and 12 will have effects on the size of the counterweight needed but is not physically limiting. However, the aesthetically inclined engineer will seek to harmonize the ratio of 11, 12 to any counterweight. 706 is the hinge pin rod connecting the frame 707 via the end of the hinge 706 to the earth 40 via vertical support 720.

FIG. 7 is a detailed drawing of the “rolling” embodiment. 700 is the “rolling embodiment” as a whole. 40 is the earth or supporting roof. 250 is the solar panel. 720 is the vertical support element. 704 is the adjustable counterweight. 705 is the bottom of the PV panel support frame. 706 is the hinge rod which connects vertical support elements 720 to each other. 710 is a connecting bracket connecting 720 to 40 ground, earth or roof.

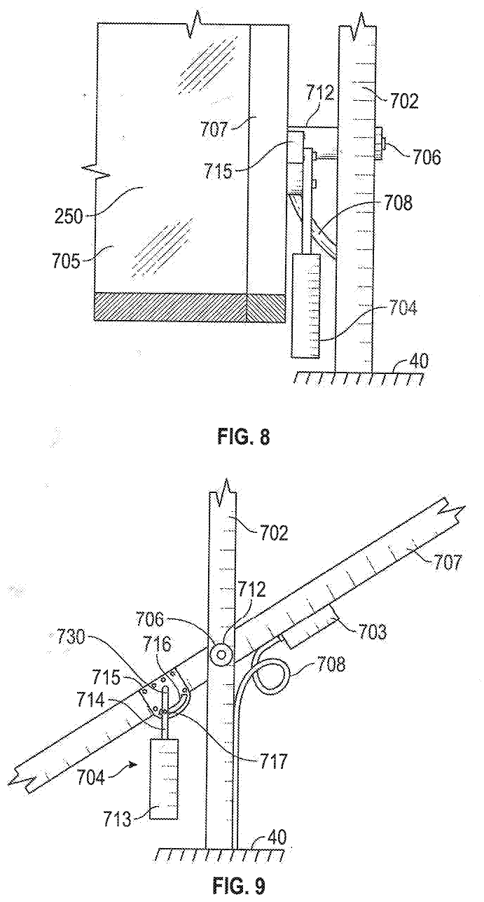

FIG. 8 is a detail view of the counterweight and hinge assembly. 250 is the solar panel. 707 is the support frame which hinge rod 712 passes through 702. Hinge rod 712 allows 707 to rotate freely in relation to vertical support element 702, which is fixed to the ground, earth, roof 40. 706 is the end of rod 712. 708 is an electrical wire connecting the panel 250 to electrical equipment. 704 is the adjustable counterweight, and 715 is a bracket allowing 704 to be adjusted in relation to 707 and the panel system center of mass.

FIG. 9 is a side view of the details in FIG. 8. 702 is the vertical support element. 703 is an electrical controller/inverter for the solar panel attached to support rail 707 and an electrical cable 708 connecting further electrical equipment to 703 and the solar panel 250. 706 is the end of the hinge rod, and 712 is the hinge rod. 707 rotates on 712 relative 702. 704 is the adjustable counterweight subsystem. 713 is the adjustable counterweight which can slide up the rod 714 via friction. Rod 714 can also pivot relative to adjustment bracket 715 via curved slot 716. Rod 714 may be threaded, friction fit to 713, or via a simple nut adjust the position of 713 down the length of rod 714. Rod 714 pivots off a pivot point centered on slot 716 in bracket 715. A simple pin provides this rotation point and 714 can use friction against slot 716 or a simple friction clamp to hold a preferred position on slot 716. Rod 714 pivots on point 730.

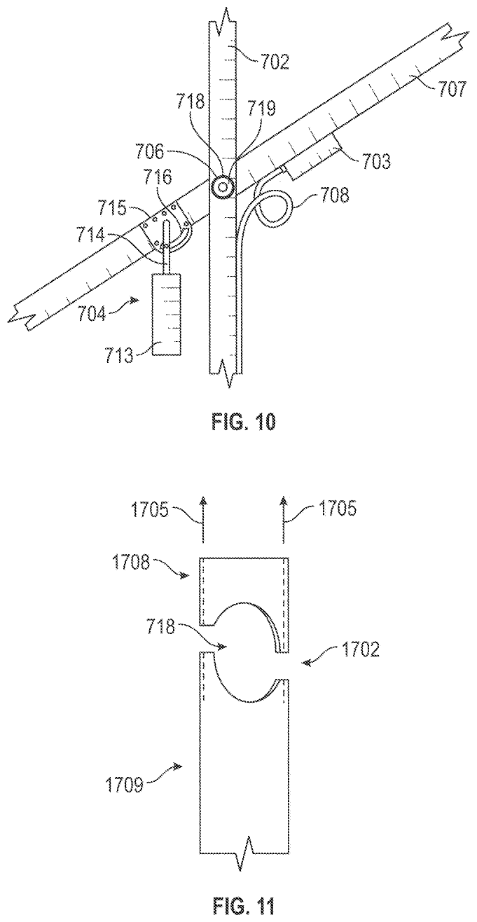

FIG. 10 is redundant to FIG. 9 and adds no new matter.

FIG. 11 is a detail of FIG. 10 showing a detail of the vertical support element.

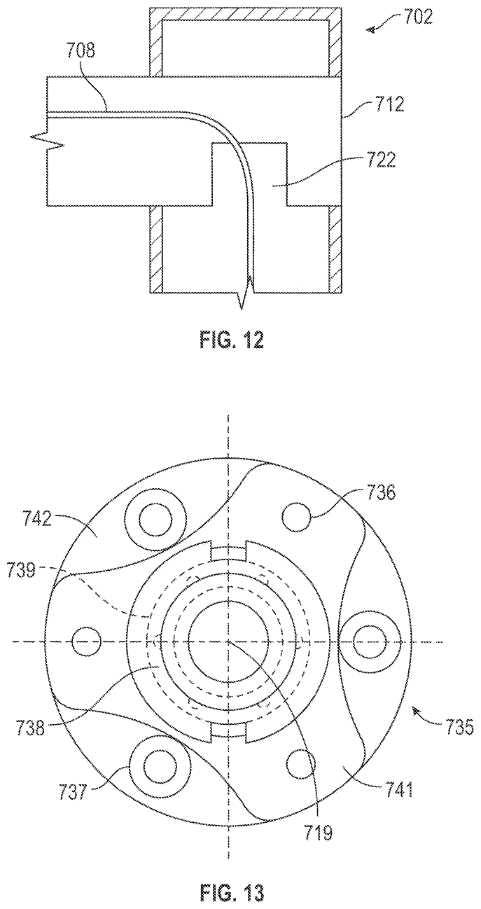

FIG. 12 is a view of one method of passing electrical wires from the solar panel down to the support elements and onward to electrical equipment. 702 is the vertical support element. 708 is an electrical wire. 712 is a hollow rotating hinge pipe, which rotates inside 702 and has a notch 722 to allow the wire to pass through. This is a limited rotation assembly. If the pipe 712 rotates past 360 degrees, it will bind the wire 708 and possibly damage it.

FIG. 13 is an alternate embodiment of a rotary hinge with pass through elements. 735 is the rotary hinge. 741 and 742 are two rotary hinge plates that rotate relative to each other with an open pass-through 719 between them. 736 is a mounting hole for 741, and 737 is a mounting hole for 742. 738 is a retaining ring for the system. 739 are washers or rotating collars for the rotary hinge.

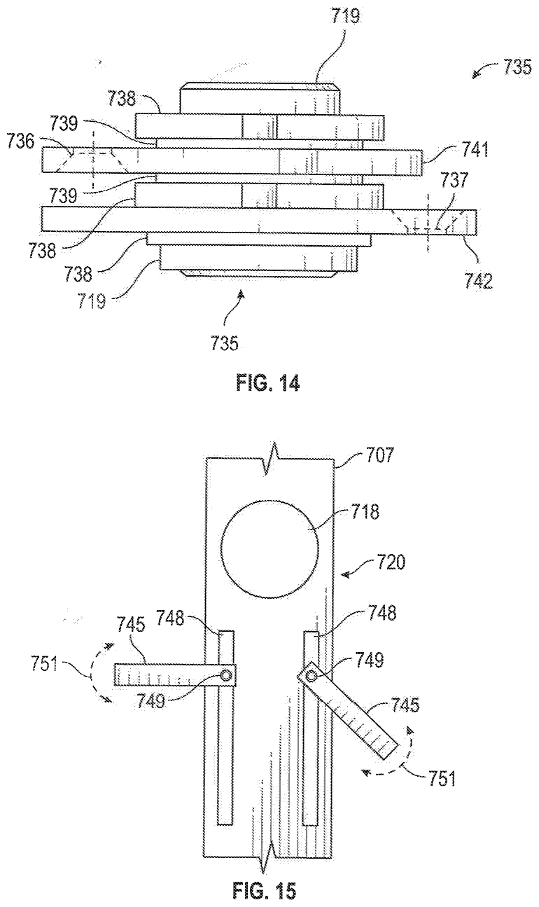

FIG. 14 is a top view of Lang FIG. 13 where 735 is the rotary hinge. 741 and 742 are two rotary hinge plates that rotate relative to each other with an open pass-through 719 between them. 736 is a mounting hole for 741, and 737 is a mounting hole for 742. 738 is a retaining ring for the system. 739 are washers or rotating collars for the rotary hinge.

FIG. 15 is an alternate design of the counterweight system. 707 is the support frame for the solar panel. 718 is the pass through for a hinge pin or rotary hinge. 748 is an adjustable slot to move a counterweight on. 745 is the support rod for a counterweight. 749 is a screw attachment point for 745 to 748. 751 depicts a preferred angle for rod 745 and counterweight (not shown).

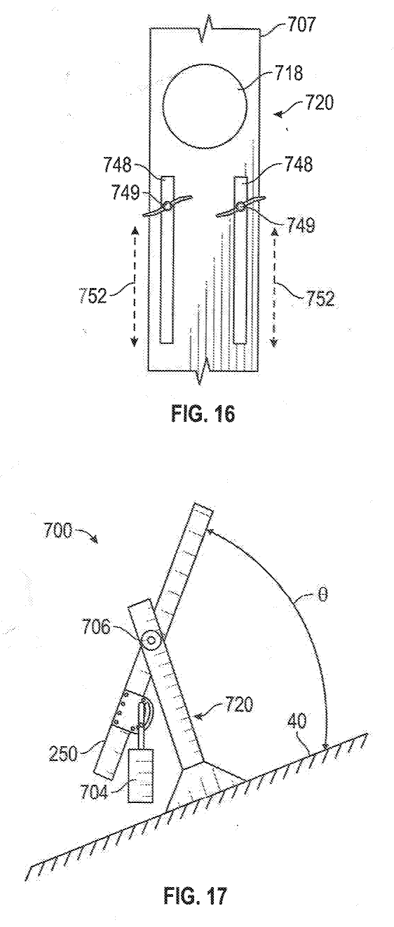

FIG. 16 is an alternate design of a counterweight system. This works especially well as described with FIG. 6 where the ratio of 11 in FIG. 6-12 in FIG. 6 is slightly uneven. FIG. 16 depicts one or more sliding masses that allow the angle of repose to be set. 707 is the solar panel support frame rail. 718 is the axis for the rotary hinge. 720 is the subject area of the drawing. 748 is a machined slot that adjustable mass 749 moves along to set a preferred angle of repose. 752 is the degree of setting or movement. 749 is any heavy mass with a simple retaining nut to allow it to hold position via friction.

FIGS. 17, 18, and 19 are all related drawings.

FIG. 17, while duplicative of FIGS. 6, 9, and 10, does show how adjusting the weight results in a preferred setting for the winter and summer. FIG. 17 shows how the system 700 responds to a setting of 704 to an extreme limit. This results in panel 250 rotating via rotary hinge 706 relative to vertical support element 720, which is fixed to ground, earth or roof 40.

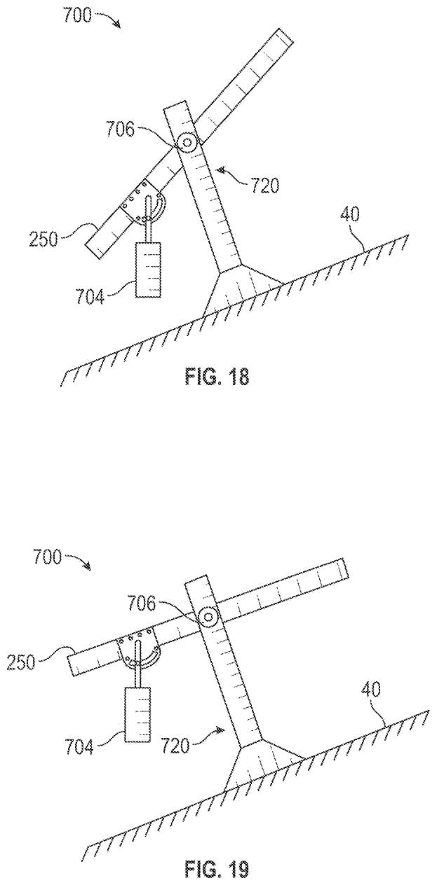

FIG. 18 shows how adjusting 704 results in a different angle of repose.

FIG. 19 shows how adjusting 704 results in a different angle of repose.

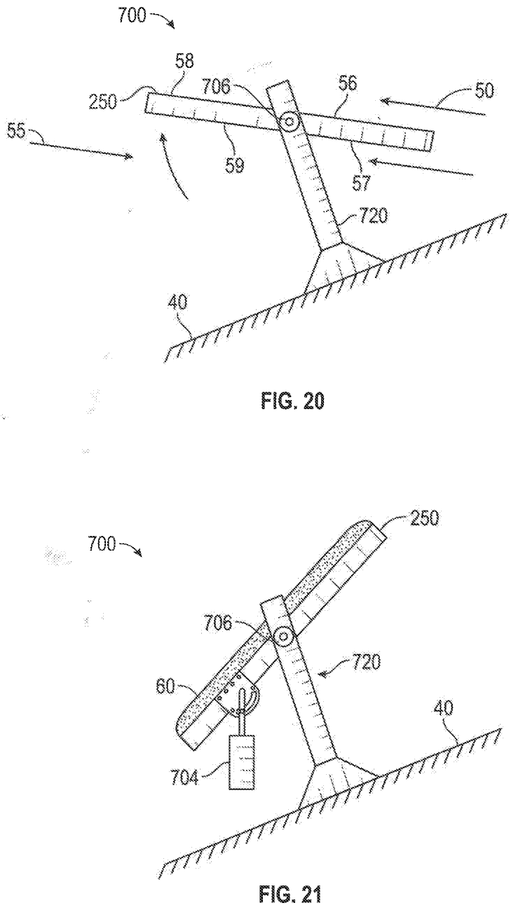

FIG. 20 shows how wind interacts with the system 700. The system, when faced with wind 50, rotates through angle 55. Panel 250 rotates around pivot 706 to provide minimum wind area. Panel surfaces 56,57, 58, and 59 will cause the panel to roll and achieve a minimum drag angle 55. The ratios of the lengths of 56 to 58 and 57 to 59 will set the wind force exerted on the panel and will set the restoring force exerted by the counterweight (not shown). Panel 250 rotates around 706 relative to 720 which is attached to ground, earth or roof 40.

FIGS. 21-23 show the system responding to snow/ice loads.

FIG. 21 shows the system 700 with panel 250 covered in snow 60. The ground 40 and rigidly affixed vertical support element 720 provide a rotation point 706 and a preferred angle of repose set by counterweight 704.

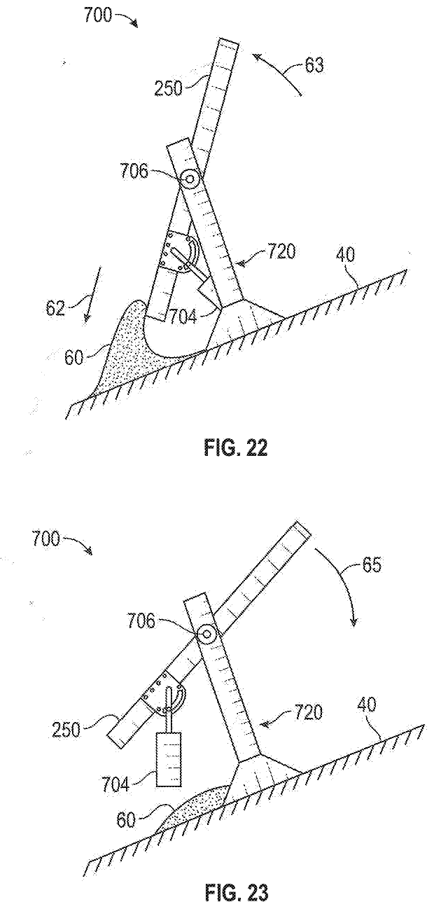

FIG. 22 shows that the unsteady accumulation of snow causes a rotation 63 of panel 250 causing snow 60 to move 62 off the panel 250 and onto the roof 40 into snow pile 60.

FIG. 23 shows the snow having fallen away 60 the system returns to its preferred orientation. Panel 250 moves relative to rotation point 706 through angle 65 as set by counterweight 704 relative to vertical element 720.

FIGS. 24-31 show a minor improvement to the “rolling” embodiment with the panel 250 augmented with a linear damper or shock absorber. There is some concern that long duration flutter may cause the panels to crack, and a small shock absorber of a low friction/low force type would reduce this flutter.

FIG. 24 shows the solar panel 250 attached via rotary hinge pin/tube 706 to vertical support element 720, which is attached to roof/earth 40. The adjustable counterweight 704, as is in FIGS. 6-23, is adjustable to the solar panel, thereby changing its center of gravity and thus slope of repose. The linear shock damper 726 is attached to the vertical support element 720 by a bolt 723 and to the panel 250 support rail 707 by a bracket 721. The linear damper is known to a PHOSITA and is commonly available.

FIG. 25 shows the “rolling” embodiment with linear damper at the maximum winter or solstice angle. The counterweight 704 is set to provide maximum elevation to panel 250, which rotates at 706 against vertical support element 720 that is connected to earth/roof 40. The linear damper is a two-part device with a main body 725 and an extension rod at near maximum extension 701 attached to bracket 721, which connects panel 250 via support rail/frame 707.

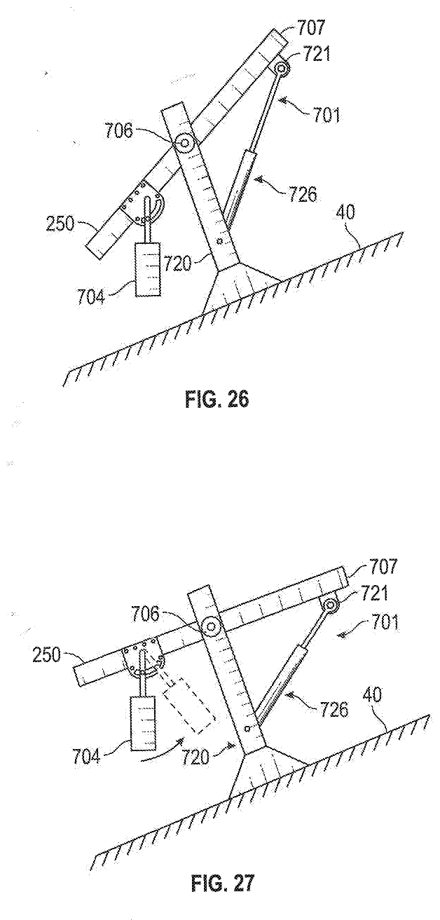

FIG. 26 shows the “rolling” embodiment with linear damper at the equinox angle. The counterweight 704 is set to provide a middle elevation to panel 250, which rotates at 706 against vertical support element 720 that is connected to ground, earth or roof 40. The linear damper is a two-part device with a main body 725 and an extension rod at medium extension 701 attached to bracket 721, which connects panel 250 via support rail/frame 707.

FIG. 27 shows the “rolling” embodiment with linear damper at the summer solstice or minimum angle. The counterweight 704 is set to provide minimum elevation to panel 250, which rotates at 706 against vertical support element 720 that is connected to ground, earth or roof 40. The linear damper is a two-part device with a main body 725 and an extension rod at near minimum extension 701 attached to bracket 721 that connects panel 250 via support rail/frame 707.

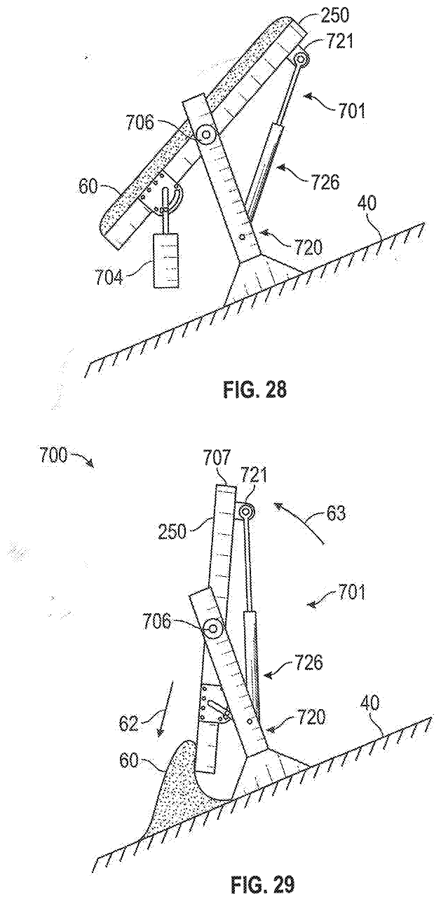

FIGS. 28 and 29 show the “rolling” embodiment of FIG. 24 behaving under snow load.

FIG. 28 shows the snow 60 built up on panel 250 holding at angle of repose set by 704 counterweight supported by pin joint 706 to vertical support 720 and ground, earth or roof 40. Motion is damped by linear damper 726 attached to vertical element 720 by bolt (not numbered) and attached to panel 250 by bracket 721.

FIG. 29 shows the system 700 adjusting to discard snow. The snow 60 has slid in direction 62 as panel 250 has rotated angle 63 relative to 720 vertical support element. Motion is damped by linear damper 726 attached to vertical element 720 by bolt (not numbered) and attached to panel 250 by bracket 721.

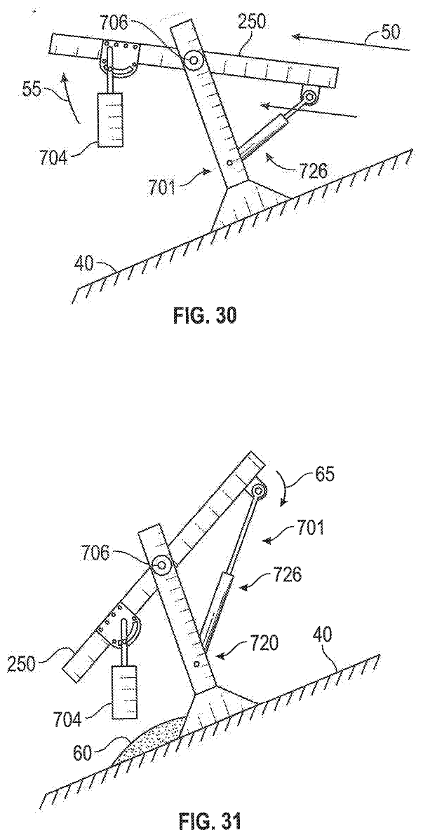

FIGS. 30 and 31 are a little redundant but show the panel after dumping snow swinging back through maximum reverse angle and then returning to the preferred angle of repose.

FIG. 30 shows the panel after dumping snow swinging back through maximum reverse angle and before returning to the preferred angle of repose. FIG. 30 also shows the effect of wind 50 causing movement 55 of the panel 250. Motion is damped by linear damper 726 attached to vertical element 720 by bolt (not numbered) and attached to panel 250 by bracket 721.

FIG. 31 the panel 250 back at the preferred angle of repose after dumping the snow 60. Motion is damped by linear damper 726 attached to vertical element 720 by bolt (not numbered) and attached to panel 250 by bracket 721.

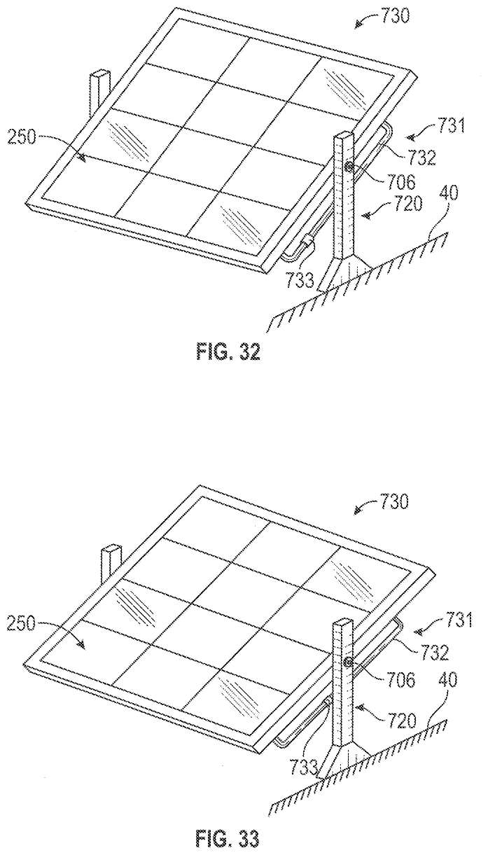

FIGS. 32-36 show the “rolling” embodiment with a weight on a sliding rod that adjusts in one axis parallel to the solar panel 250 rather then at an angle incident to 250 as in FIGS. 6-23.

FIG. 32 shows the panel 250 engaging in rolling motion 730 due to a pivot of 706. The center of gravity for panel 250 and the mass 733 move on rail 732. Rod and mass system 731 perform the same function as 704 in other embodiments of the “rolling” embodiment, but is a convenient implementation. Mass 733 is friction fit or uses a small bolt (not pictured) to hold position.

FIG. 33 shows an effect of angle of repose as mass 733 moves partway along rod 732. Panel 250 rotates as indicated in direction 730 along hinge pin 706 against vertical support element 720 attached to ground, earth or roof 40.

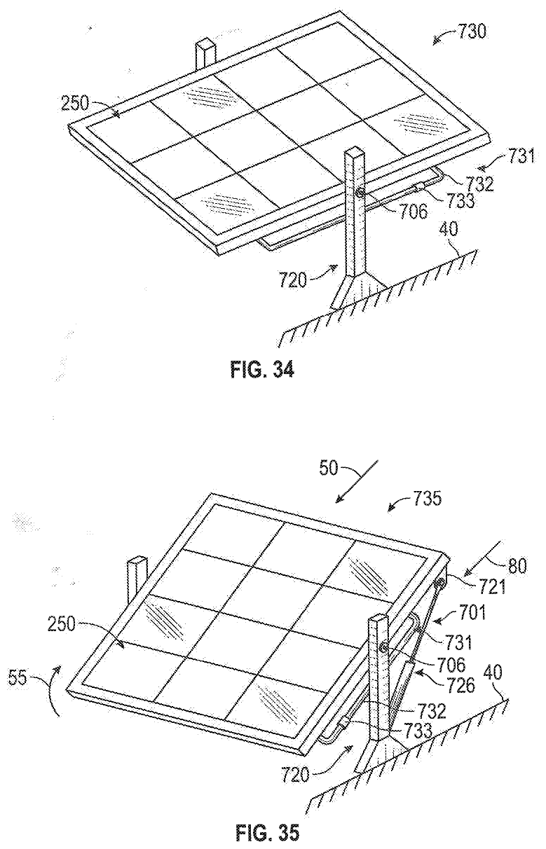

FIG. 34 shows an effect of angle of repose as mass 733 moves all the way along rod 732. Panel 250 rotates as indicated in direction 730 along hinge pin 706 against vertical support element 720 attached to ground, earth or roof 40.

FIG. 35 shows the “rolling” embodiment with the sliding mass on a rod and a linear damper 726. The effect of wind 50 moves the panel 250 against hinge pin 706 from the preferred angle of repose. Panel 250 rotates relative to vertical support element 720 attached to ground, earth or roof 40. The linear damper 726 moves rod 701 attached to bracket 721 and causes a compression of the damper rod 701 along angle 80.

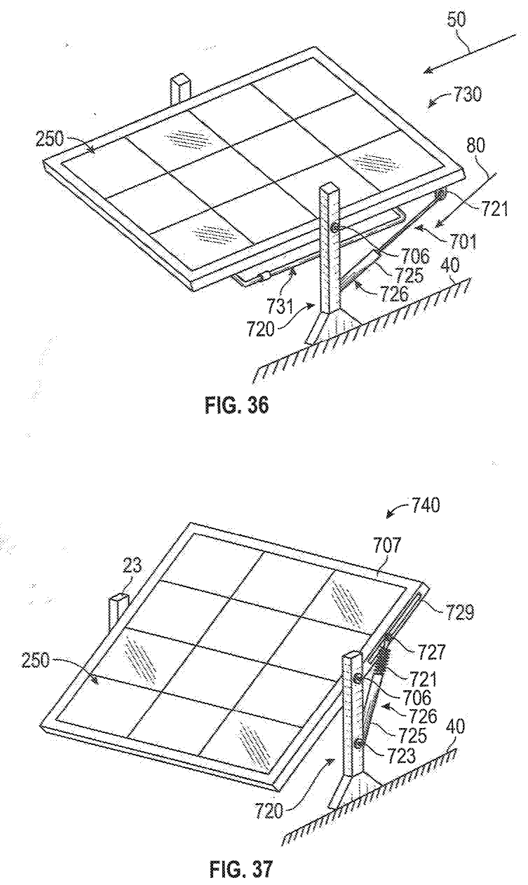

FIG. 36 shows the “rolling” embodiment with the sliding mass on a rod and a linear damper 726. The effect of wind 50 moves the panel 250 to horizontal against hinge pin 706 from the preferred angle of repose. Panel 250 rotates relative to vertical support element 720 attached to earth/roof 40. The linear damper 726 moves rod 701 attached to bracket 721 and causes a compression of the damper rod 701 along angle 80.

FIGS. 37-39 replace the counterweight with a spring loaded damper.

FIG. 37 shows a spring-loaded damper 726 that has a preferred middle hold spot much like a McPherson strut on a car suspension. The panel support rail 707 is cut with a slot 729. The spring-loaded damper 726 is attached at a preferred spot in the slot 729 via bolt 727. The damper 726 is attached to vertical support element 720 via bolt 723.

FIG. 38 shows a spring-loaded damper 726 that has a preferred middle hold spot much like a McPherson strut on a car suspension. The panel support rail 707 is cut with a slot 729. The spring-loaded damper 726 is attached at a preferred spot in the slot 729 via bolt 727; this spot is adjusted versus FIG. 37 to adjust the angle of repose. Movement of attachment point 727 in direction 58 causes a rotation 57 of panel 250, therefore creating an adjusted angle of repose. The damper 726 is attached to vertical support element 720 via bolt 723.

FIG. 39 shows a spring-loaded damper 726 that has a preferred middle hold spot much like a McPherson strut on a car suspension. The panel support rail 707 is cut with a slot 729. The spring-loaded damper 726 is attached at a preferred spot in the slot 729 via bolt 727; this spot is adjusted to horizontal versus FIG. 37 to adjust the angle of repose. Movement of attachment point 727 in direction 58 causes a rotation 57 of panel 250, therefore creating an adjusted angle of repose. The damper 726 is attached to vertical support element 720 via bolt 723.

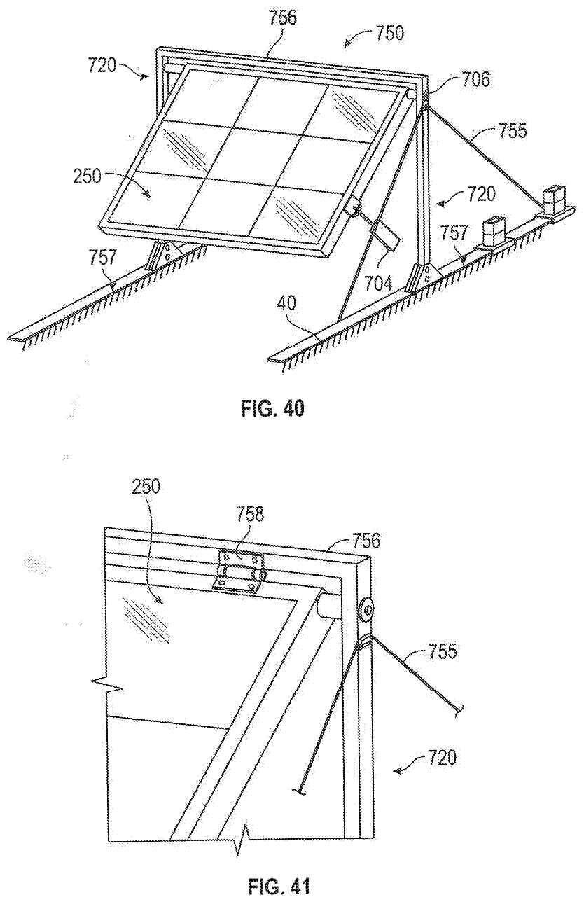

FIG. 40 is an embodiment of the rolling motion. The attach point for the hinge pin 706 has been moved to the top edge of solar panel 250 to vertical support 720. Solar panel 250 has a rolling motion around hinge pin 706. Vertical support 720 is connected to another vertical support 720 by horizontal support 756. Vertical support 720 is tension-stayed by guy-wire 755 to a horizontal support 757. The horizontal support is in frictional contact with the ground, earth or roof 40. Solar panel 250 is adjusted to angle of repose by movement of counterweight 704.

FIG. 41 is a detail of the hinge assembly of FIG. 40. Hinge 758 can replace hinge pin 706. The drawings are duplicative of these hinge mechanisms as any of a number of hinge mechanisms, including flexible straps, magnetic suspension, or any method known to a PHOSITA would work to provide rotation between panel 250 and its support frame and the fixed supports 720,756 and guy wires 755.

FIG. 42 is the “spinning” embodiment of the subject invention. The embodiment shows a variation in angle of repose for solar panel 250 by adjusting the position of horizontal support 807 is adjusted via adjustment nut 802 to vertical support 803 and solar panel 250 is adjusted via horizontal support 809 which is pin joined to foot 805 which is sliding in horizontal support element 45 via track 48 as detailed in FIG. 43. Solar panel 250 engages in a spinning motion 824 via pin joint 804. The spinning motion 824 relieves wind load (900). Solar panel 250 is attached to frame support rail 707, which is attached to pint joint 804 to horizontal support elements 807 and 809. Attachment nut 802 moves in slot 829 vertically. Vertical element 820 is cable-stayed via guy wire 855 and via bracket 810 to horizontal element 845. Pin joint 804 is offset by the ratio of A to B from the geometric center of the panel and then a counterweight (Not shown) is slid on a rod to offset the torque created by the effect of gravity on panel 250 against the rotation point 804. Additional information is in FIG. 70.

FIG. 43 is a detail drawing of the horizontal element showing 45 and track 48.

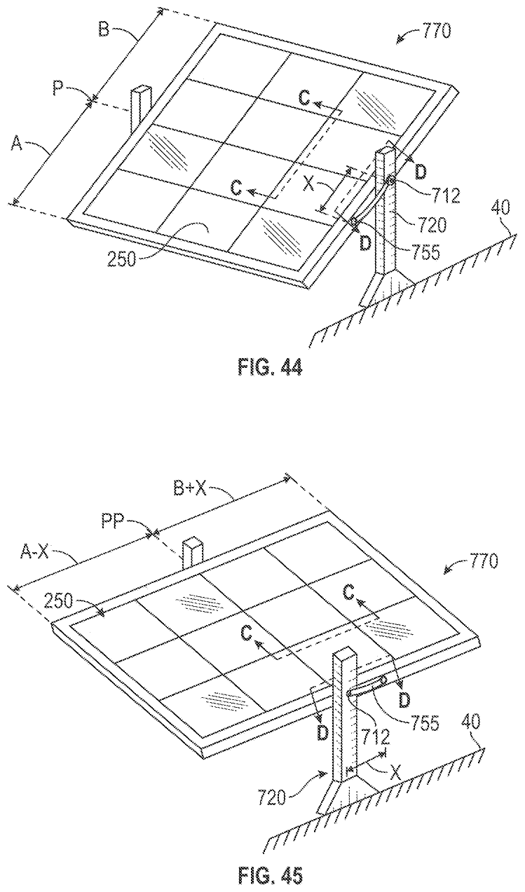

FIGS. 44 and 45 describe a solar panel 250 with a curved slot which allows the panel's own mass to serves as a counterweight to establish a preferred angel of repose. By adjusting the ratio of the attachment point D, numbered as 712, between A and B, the panel can establish its own preferred angel of repose. Panel 250 is attached via retaining nuts at 712 to vertical support element 720 to earth 40.

FIG. 45 is an alternate view of FIG. 44 with the panel from slot 755 in panel frame 770 limited from the geometric center to the midpoint of the distance from the geometric center to B. This distance X is depicted.

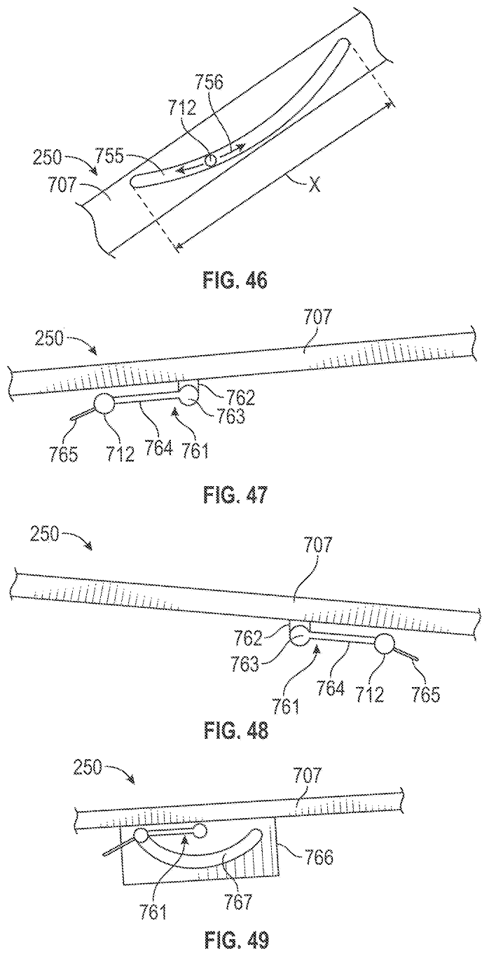

FIG. 46 is a detail of the slot in solar panel 250's support frame. The point of rotation 712 may move in direction 756 or angle 755 to adjust angle of repose.

FIG. 47 shows an alternate counterweight detail. Solar panel 250 with support rail 707 has an attachment bracket 762 with a rotating adjustable counterweight system 761. Counterweight system 761 has a rotating joint at 763, an arm 764, a mass 712, and an arm at 765. Mass 712 may be solid or a fluid damper as described later.

FIG. 48 shows an alternate counterweight detail. Solar panel 250 with support rail 707 has an attachment bracket 762 with a rotating adjustable counterweight system 761. Counterweight system 761 has a rotating joint at 763, an arm 764, a mass 712, and an arm at 765. Mass 712 may be solid or a fluid damper as described later. Rotating joint 763 is set to the alternate extreme position.

FIG. 49 is the device as described in FIGS. 47 and 48 with the addition of an indicating gauge bracket 766. Solar panel 205 attached to support rail 707 is attached to indicating support bracket 766. Indicating support bracket 766 has adjustable counterweight 761 as described in FIGS. 47 and 48. Adjustable counterweigh 761 may move thought semicircular slot semicircular slot 767 to achieve a preferred angle of repose.

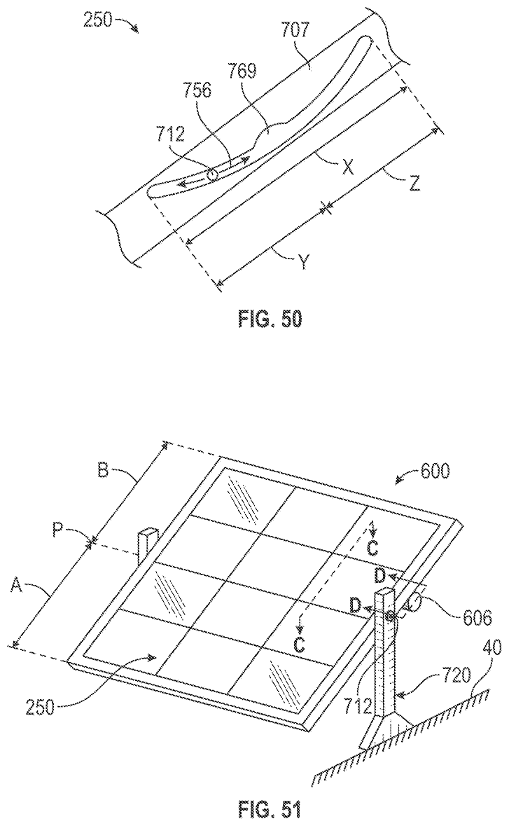

FIG. 50 is an improvement on FIG. 46 with a notched detent 769 to provide a midpoint for cleaning area for point of rotation 712. Solar Panel 250 is attached to support rail 707, which has a curvilinear slot (not numbered) may move in direction 756 or direction (not numbered).

FIG. 51 shows the “rolling” embodiment with an adjustable fluid damper used as the counterweight. Solar panel 250 has a rotating hinge 712 attached to vertical support 720 attached to ground, earth or roof 40 attached to fluid damper 606, which is moved distance D within zone C to establish a preferred angle of repose. Distance A and B do not have to be equidistant but are preferred to be approximately similar in length.

FIG. 52 shows a schematic view of a simple fluid damper. Panel 250 would create a standoff distance G, which would have a fluid damper 609 comprised of a shell 607, a viscous fluid 612, air or neutral gas 614. The fluid damper 609 is exposed to external air 606. A viscous fluid 612 is any liquid or fine powder designed to cause mechanical energy loss in a rotary damper, that is a damper that undergoes mechanical motion and causes energy loss due to internal fluid friction. Typical viscous fluids would be water, water/alcohol, glycerol, hydraulic fluid, machine oil. Dry sand, small BB's or round bearings or even rice grains and pulses (beans) would also exhibit the effect needed, although water mixed with anti-freeze would be a preferred solution.

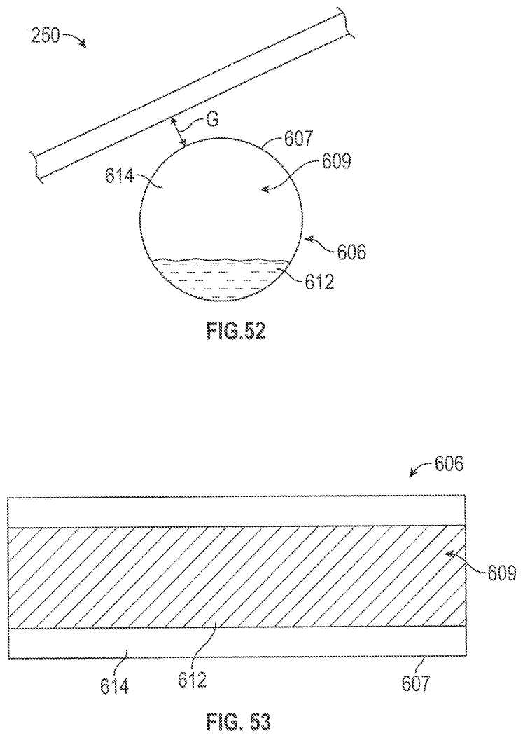

FIG. 53 is a plan view drawing of the fluid damper 609. Panel 250 would create a standoff distance G, which would have a fluid damper 609 comprised of a shell 607, a viscous fluid 612, air or neutral gas 614. The fluid damper 609 is exposed to external air 606.

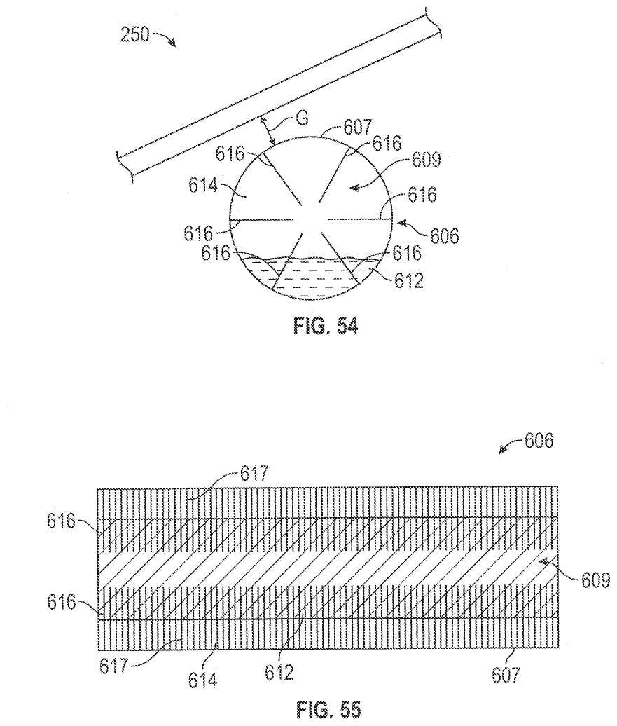

FIG. 54 is an improved version of the fluid damper 609. Panel 250 would create a standoff distance G, which would have a fluid damper 609 comprised of a shell 607, a viscous fluid 612, air or neutral gas 614. The fluid damper 609 is exposed to external air 606. Shell 607 has slotted radial baffles 616, which increase viscous drag.

FIG. 55 is a plan view diagram of FIG. 54. Panel 250 would create a standoff distance G, which would have a fluid damper 609 comprised of a shell 607, a viscous fluid 612, air or neutral gas 614. The fluid damper 609 is exposed to external air 606. Shell 607 has slotted radial baffles 616, which increase viscous drag.

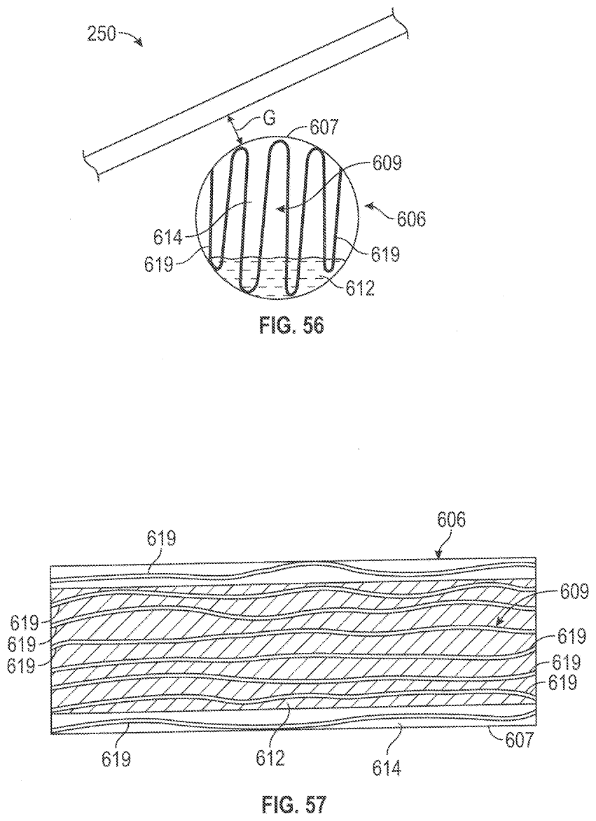

FIG. 56 is an alternate embodiment of the fluid damper 609 with a continuous, perforated baffle rather than a radial perforated baffle. Panel 250 would create a standoff distance G, which would have a fluid damper 609 comprised of a shell 607, a viscous fluid 612, air or neutral gas 614. The fluid damper 609 is exposed to external air 606. Visible is perforated, serpentine baffle material 619 installed in a loose manner within the damper 609.

FIG. 57 is a pan view drawing FIG. 56. Panel 250 would create a standoff distance G, which would have a fluid damper 609 comprised of a shell 607, a viscous fluid 612, air or neutral gas 614. The fluid damper 609 is exposed to external air 606. Visible is perforated, serpentine baffle material 619 installed in a loose manner within the damper 609.

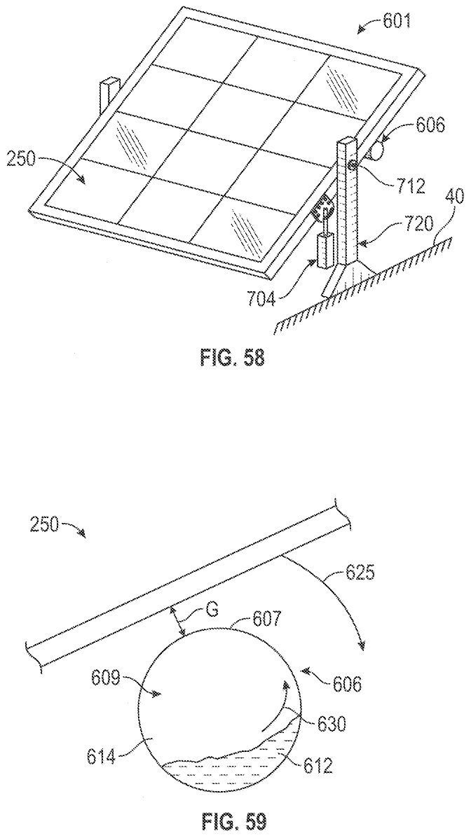

FIG. 58 is a depiction of the “rolling” embodiment of the subject invention with a fluid damper attached. Solar panel 250 has adjustable counterweight 704 and fluid damper 606 with rotating hinge 712 attached to vertical support element 720 attached to ground, earth or roof 40.

FIG. 59 show the simple fluid damper as described in FIG. 52 in motion. Panel 250 would create a standoff distance G, which would have a fluid damper 609 comprised of a shell 607, a viscous fluid 612, air or neutral gas 614. The fluid damper 609 is exposed to external air 606. Solar panel 250 moving in direction 625 causes viscous fluid 612 to move in direction 630, damping energy from the system.

FIG. 60 shows the same motion as in FIG. 59 in the opposite direction. Panel 250 would create a standoff distance G, which would have a fluid damper 609 comprised of a shell 607, a viscous fluid 612, air or neutral gas 614. The fluid damper 609 is exposed to external air 606. Solar panel 250 moving in direction 625 causes viscous fluid 612 to move in direction 630, damping energy from the system.

FIG. 61 shows the “rolling” embodiment of the subject matter invention where the rotary damper is used as an adjustable counterweight. Solar panel 250 is attached via rotating hinge 712 to vertical support 720 attached to ground, earth or roof 40. Rotary damper 606 stands off from panel 250 a fixed distance by arm 611. Damper 606 moves in slot 610 in frame rail 707. Arm 611 is attached to slot 610 by adjustment nut 613.

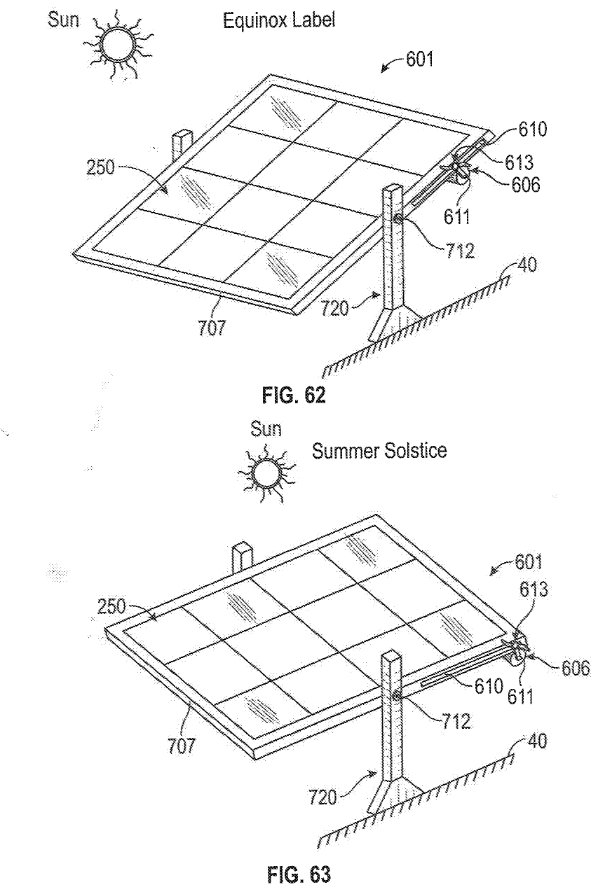

FIG. 62 shows the rotary damper placed in different positions in slot 610 to adjust angle of repose. Solar panel 250 is attached via rotating hinge 712 to vertical support 720 attached to ground, earth or roof 40. Rotary damper 606 stands off from panel 250 a fixed distance by arm 611. Damper 606 moves in slot 610 in frame rail 707. Arm 611 is attached to slot 610 by adjustment nut 613.

FIG. 63 shows the rotary damper placed in different positions in slot 610 to adjust angle of repose. Solar panel 250 is attached via rotating hinge 712 to vertical support 720 attached to earth/roof 40. Rotary damper 606 stands off from panel 250 a fixed distance by arm 611. Damper 606 moves in slot 610 in frame rail 707. Arm 611 is attached to slot 610 by adjustment nut 613. This is a typical angle of repose for summer solstice.

FIG. 70 shows a plan view drawing of FIG. 42 which includes the rotating joint 804 offsets A-B of Joint 804 and horizontal support 807, adjustment nut 802, vertical support 803. Most importantly, it shows the back side of panel 250 with counterweight system 731, rod 732 and mass 733.

It is to be understood that the present invention is not limited to the embodiments and non-limiting examples described above or as shown in the attached figures, but encompasses any and all embodiments within the spirit of the invention.

What is claimed is:

1. An environment-adjusting, support system for solar energy devices, said support system comprising:
a pair of vertical support elements secured to a support surface,
wherein each of said vertical support elements comprises a first end, a second end, and a body extending between said first end and said second end; and
at least one rotary element securing a solar energy device to said vertical support elements,
wherein said at least one rotary element allows the solar energy device to rotate in an axis connecting said vertical support elements such that the solar energy device is able to rotate under effects of environmental forces to minimize mechanical load transferred to said vertical support elements and the support surface.

2. The environment-adjusting, support system according to claim 1, wherein said at least one rotary element is selected from the group consisting of a hinge, a rod, a joint, and any combination thereof.

3. The environment-adjusting, support system according to claim 1, further comprising a linear damper connecting the solar energy device and one of said vertical support elements.

4. The environment-adjusting, support system according to claim 3, wherein said linear damper adjustably connects the solar energy device and one of said vertical support elements.

5. The environment-adjusting, support system according to claim 1, further comprising at least one adjustable counterweight, wherein said at least one adjustable counterweight is secured to the solar energy device such that said at least one adjustable counterweight causes the solar energy device to maintain a preferred angle of repose of the solar energy device relative to the support surface due to gravitational forces.

6. The environment-adjusting, support system according to claim 5, wherein the solar energy device will rotate under effects of environmental forces and minimize mechanical forces transferred to said vertical support elements and the support surface.

7. The environment-adjusting, support system according to claim 5, wherein at least one of said at least one adjustable counterweight is an energy damper.

8. The environment-adjusting, support system according to claim 5, wherein said at least one adjustable counterweight is adjustable to a surface of the solar energy device in a distance from a hinge point of the solar energy device and offset away from the surface of the solar energy device to adjust the center of gravity of the solar energy device.

9. The environment-adjusting, support system according to claim 5, further comprising an energy damper that is secured to the solar energy device.

10. The environment-adjusting, support system according to claim 9, wherein said at least one adjustable counterweight is adjustable to a surface of the solar energy device in a distance from a hinge point of the solar energy device and offset away from the surface of the solar energy device to adjust the center of gravity of the solar energy device.

11. The environment-adjusting, support system according to claim 5, further comprising a linear damper connecting the solar energy device and one of said vertical support elements.

12. The environment-adjusting, support system according to claim 11, wherein said linear damper adjustably connects the solar energy device and one of said vertical support elements.

13. An environment-adjusting, support system for solar energy devices, said support system comprising:
a pair of vertical support elements secured to a support surface,
wherein each of said vertical support elements comprises a first end, a second end, and a body extending between said first end and said second end;
a pair of securing members,
wherein each of said pair of securing members is secured to the support surface and is positioned forward of a corresponding vertical support element of said vertical support elements;
a first connecting element connecting said pair of vertical support elements,
wherein said first connecting element comprises a first end, a second end, and a body extending between said first end and said second end of said first connecting element;
a second connecting element connecting said pair of securing members,
wherein said second connecting element comprises a first end, a second end, and a body extending between said first end and said second end of said second connecting element; and
at least one rotary element securing a solar energy device to said first connecting element and said second connecting element,
wherein said at least one rotary element allows the solar energy device to rotate in an axis generally perpendicular of said first connecting element and said second connecting element such that the solar energy device is able to rotate under effects of environmental forces to minimize mechanical load transferred to said vertical support elements and the support surface.

14. An environment-adjusting, solar energy apparatus, said solar energy apparatus comprising:
a solar energy device;
a pair of vertical support elements secured to a support surface,
wherein each of said vertical support elements comprises a first end, a second end, and a body extending between said first end and said second end; and
at least one rotary element securing said solar energy device to said vertical support elements,
wherein said at least one rotary element allows said solar energy device to rotate in an axis connecting said vertical support elements such that said solar energy device is able to rotate under effects of environmental forces to minimize mechanical load transferred to said vertical support elements and the support surface.

15. The solar energy apparatus according to claim 14, wherein said solar energy device is a photovoltaic panel.

16. The solar energy apparatus according to claim 14, wherein said at least one rotary element is selected from the group consisting of a hinge, a rod, a joint, and any combination thereof.

17. The solar energy apparatus according to claim 14, further comprising a linear damper connecting said solar energy device and one of said vertical support elements.

18. The solar energy apparatus according to claim 17, wherein said linear damper adjustably connects said solar energy device and one of said vertical support elements.

19. The solar energy apparatus according to claim 14, further comprising at least one adjustable counterweight, wherein said at least one adjustable counterweight is secured to said solar energy device such that said at least one adjustable counterweight causes said solar energy device to maintain a preferred angle of repose of said solar energy device relative to the support surface due to gravitational forces.

20. The solar energy apparatus according to claim 19, wherein said solar energy device will rotate under effects of environmental forces and minimize mechanical forces transferred to said vertical support elements and the support surface.

21. The solar energy apparatus according to claim 19, wherein at least one of said at least one adjustable counterweight is an energy damper.

22. The solar energy apparatus according to claim 19, wherein said at least one adjustable counterweight is adjustable to a surface of said solar energy device in a distance from a hinge point of said solar energy device and offset away from said surface of said solar energy device to adjust the center of gravity of said solar energy device.

23. The solar energy apparatus according to claim 19, further comprising an energy damper that is secured to the solar energy device.

24. The solar energy apparatus according to claim 23, wherein said at least one adjustable counterweight is adjustable to a surface of said solar energy device in a distance from a hinge point of said solar energy device and offset away from said surface of said solar energy device to adjust the center of gravity of said solar energy device.

25. The solar energy apparatus according to claim 18, further comprising a linear damper connecting said solar energy device and one of said vertical support elements.

26. The solar energy apparatus according to claim 25, wherein said linear damper adjustably connects said solar energy device and one of said vertical support elements.
